(19) United States
(12) Patent Application Publication
(10) Pub. No.: US 2024/0313969 A1
(43) Pub. Date: Sep. 19, 2024

(54) ESTABLISHING A TRUST RELATIONSHIP BETWEEN AN APPLICATION ENTITY AND A WIRELESS COMMUNICATION NETWORK

(71) Applicant: Lenovo (Singapore) Pte. Ltd., New Tech Park (SG)

(72) Inventors: Andreas Kunz, Ladenburg (DE); Ishan Vaishnavi, München (DE); Emmanouil Pateromichelakis, Viersen (DE); Sheeba Backia Mary Baskaran, Friedrichsdorf (DE)

(21) Appl. No.: 18/576,042

(22) PCT Filed: Aug. 24, 2021
(86) PCT No.: PCT/EP2021/073414

§ 371 Date: Jan. 2, 2024

(30) Foreign Application Priority Data
Jul. 2, 2021 (GR) 20210100453

(51) Int. Cl. H04L 9/32; H04L 9/40

(52) U.S. Cl. CPC H04L 9/321; H04L 63/0807

(57) ABSTRACT

Apparatuses, methods, and systems are disclosed for establishing a trust relationship between an application entity and a wireless communication network. One apparatus (600) includes a processor (605) and a transceiver (625). The transceiver (625) sends, from an application entity, a request to a first network function to authenticate the application entity to a second network function that does not have a trust relationship with the application entity and receives a result of the authentication from at least one of the first and second network functions. The processor (605) establishes a trust relationship between the application entity and the second network function such that the application entity can communicate with the second network function in response to the application entity being authenticated.

### FIELD

The subject matter disclosed herein relates generally to wireless communications and more particularly relates to establishing a trust relationship between an application entity and a wireless communication network.

### BACKGROUND

In wireless networks, a vertical application, e.g., an application entity such as an application function, may use middleware services to request management services as well as control plane services such as a new slice on demand, based on an agreement between the vertical application and the network slice provider.

### BRIEF SUMMARY

Disclosed are procedures for establishing a trust relationship between an application entity and a wireless communication network. Said procedures may be implemented by apparatus, systems, methods, and/or computer program products.

One method of an application entity in a mobile communication network includes sending, from an application entity, a request to a first network function to authenticate the application entity to a second network function that does not have a trust relationship with the application entity. The first network function may have a trust relationship with the application entity and the second network function. The request may include at least one verifiable parameter for authenticating the application entity. The method further includes receiving a result of the authentication from at least one of the first and second network functions and establishing a trust relationship between the application entity and the second network function such that the application entity can communicate with the second network function in response to the application entity being authenticated.

One method of a middleware includes generating, at a first network function, a client credential assertion (“CCA”) token for the first network function and sending, from the first network function, an authentication request to a second network function for authenticating an application entity, the authentication request comprising the CCA token of the first network function, the application entity having a trust relationship with the first network function and not the second network function. The method further includes receiving, at the first network function from the second network function, a response to the authentication request comprising a network address identifier (“NAI”) for the second network function and sending, from the first network function to the application entity, the response to the authentication request comprising the NAI for the second network function and the CCA token of the first network function for establishing a security association between the application entity and the second network function.

One method of a network function includes receiving, at a first network function, an authentication request from an application entity that does not have a trust relationship with the first network function. The authentication request comprises a client credential assertion (“CCA”) token for a second network function that has a trust relationship with the first network function and the application entity. The method further includes verifying, at the first network function, that the CCA token is associated with the second network function and sending, from the first network function to the application entity, an authentication result in response to verifying the CCA token, the authentication result comprising a CCA token of the first network function for establishing a security association between the application entity and the third network function.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for establishing a trust relationship between an application entity and a wireless communication network;

FIG. 2 is a diagram illustrating one embodiment of trust relationships between entities within a wireless communication network;

FIG. 3A is a signal flow diagram illustrating one embodiment of a procedure for establishing a trust relationship between an application entity and a wireless communication network;

FIG. 3B is a continuation of the procedure depicted in FIG. 3A;

FIG. 4A is a signal flow diagram illustrating one embodiment of another procedure for establishing a trust relationship between an application entity and a wireless communication network;

FIG. 4B is a continuation of the procedure depicted in FIG. 4A;

FIG. 5 is a block diagram illustrating one embodiment of a user equipment apparatus that may be used for establishing a trust relationship between an application entity and a wireless communication network;

FIG. 6 is a block diagram illustrating one embodiment of a network apparatus that may be used for establishing a trust relationship between an application entity and a wireless communication network;

FIG. 7 is a flowchart diagram illustrating one embodiment of a method for establishing a trust relationship between an application entity and a wireless communication network;

FIG. 8 is a flowchart diagram illustrating one embodiment of another method for establishing a trust relationship between an application entity and a wireless communication network; and

FIG. 9 is a flowchart diagram illustrating one embodiment of another method for establishing a trust relationship between an application entity and a wireless communication network.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more 15 of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for establishing a trust relationship between an application entity and a wireless communication network. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

A vertical application e.g., an application entity or an application function (AF), may request management services as well as control plane services, e.g., via a middleware service, such as a new slice on demand, based on an agreement between the vertical and the network slice provider. However, the creation of a new slice will require a form of trust between the vertical/end application and the 5GS (e.g., the management and control plane) for authorizing/authenticating the application request and enabling the vertical app to consume management/control services related to the requested slice.

The vertical application/AF, however, may not be trusted by the management service (“MnS”) producer or the control plane (“CP”) and is therefore not able to access CP or management plane (“MP”) services. So, there is an issue as to how to enable the authorization/authentication of the vertical application to consume telco-provided services (e.g., management and control plane services), based on the vertical application's request, which the vertical application/AF may need to directly access the MnS implementation and CP services for managing and controlling its network slice. The subject matter described herein provides a solution for establishing a trust-relationship between the AF and the MnS producer and/or CP to enable access to the MnS implementation and CP services.

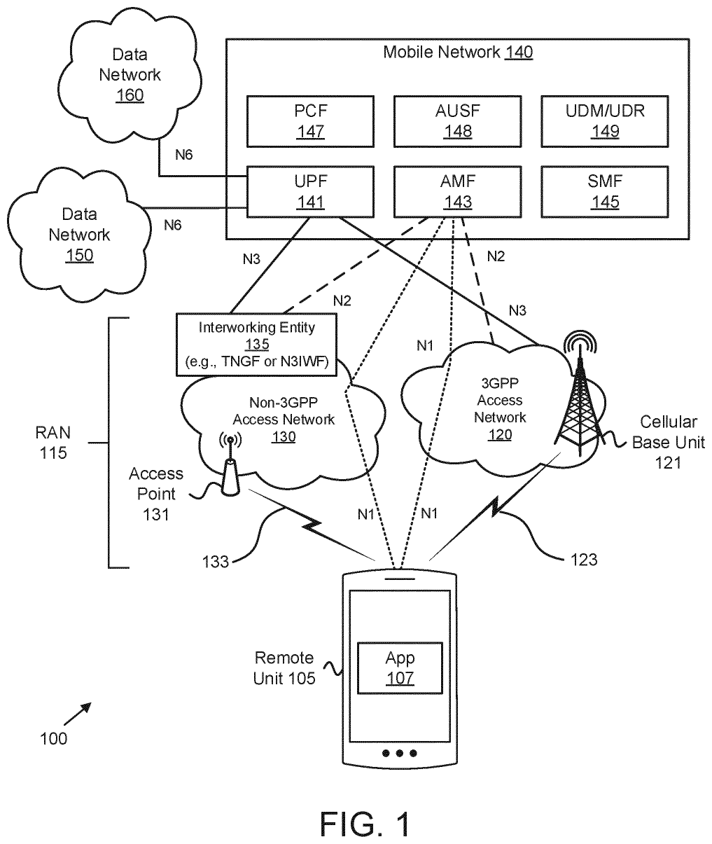

FIG. 1 depicts a wireless communication system 100 for establishing a trust relationship between an application entity and a wireless communication network, according to embodiments of the disclosure. In one embodiment, the wireless communication system 100 includes at least one remote unit 105, a Fifth-Generation Radio Access Network (“5G-RAN”) 115, and a mobile core network 140. The 5G-RAN 115 and the mobile core network 140 form a mobile communication network. The 5G-RAN 115 may be composed of a 3GPP access network 120 containing at least one cellular base unit 121 and/or a non-3GPP access network 130 containing at least one access point 131. The remote unit 105 communicates with the 3GPP access network 120 using 3GPP communication links 123 and/or communicates with the non-3GPP access network 130 using non-3GPP communication links 133. Even though a specific number of remote units 105, 3GPP access networks 120, cellular base units 121, 3GPP communication links 123, non-3GPP access networks 130, access points 131, non-3GPP communication links 133, and mobile core networks 140 are depicted in FIG. 1, one of skill in the art will recognize that any number of remote units 105, 3GPP access networks 120, cellular base units 121, 3GPP communication links 123, non-3GPP access networks 130, access points 131, non-3GPP communication links 133, and mobile core networks 140 may be included in the wireless communication system 100.

In one implementation, the RAN 120 is compliant with the 5G system specified in the Third Generation Partnership Project (“3GPP”) specifications. For example, the RAN 120 may be a NG-RAN, implementing NR RAT and/or LTE RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as UEs, subscriber units, mobiles, mobile stations, users, terminals, mobile terminals, fixed terminals, subscriber stations, user terminals, wireless transmit/receive unit (“WTRU”), a device, or by other terminology used in the art.

The remote units 105 may communicate directly with one or more of the cellular base units 121 in the 3GPP access network 120 via uplink (“UL”) and downlink (“DL”) communication signals. Furthermore, the UL and DL communication signals may be carried over the 3GPP communication links 123. Similarly, the remote units 105 may communicate with one or more access points 131 in the non-3GPP access network(s) 130 via UL and DL communication signals carried over the non-3GPP communication links 133. Here, the access networks 120 and 130 are intermediate networks that provide the remote units 105 with access to the mobile core network 140.

In some embodiments, the remote units 105 communicate with a remote host (e.g., in the data network 150 or in the data network 160) via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the 5G-RAN 115 (i.e., via the 3GPP access network 120 and/or non-3GPP network 130). The mobile core network 140 then relays traffic between the remote unit 105 and the remote host using the PDU session. The PDU session represents a logical connection between the remote unit 105 and a User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. Additionally—or alternatively—the remote unit 105 may have at least one PDU session for communicating with the packet data network 160. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

As described in greater detail below, the remote unit 105 may use a first data connection (e.g., PDU Session) established with the first mobile core network 130 to establish a second data connection (e.g., part of a second PDU session) with the second mobile core network 140. When establishing a data connection (e.g., PDU session) with the second mobile core network 140, the remote unit 105 uses the first data connection to register with the second mobile core network 140.

The cellular base units 121 may be distributed over a geographic region. In certain embodiments, a cellular base unit 121 may also be referred to as an access terminal, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a Home Node-B, a relay node, a device, or by any other terminology used in the art. The cellular base units 121 are generally part of a radio access network (“RAN”), such as the 3GPP access network 120, that may include one or more controllers communicably coupled to one or more corresponding cellular base units 121. These and other elements of radio access network are not illustrated but are well known generally by those having ordinary skill in the art. The cellular base units 121 connect to the mobile core network 140 via the 3GPP access network 120.

The cellular base units 121 may serve a number of remote units 105 within a serving area, for example, a cell or a cell sector, via a 3GPP wireless communication link 123. The cellular base units 121 may communicate directly with one or more of the remote units 105 via communication signals. Generally, the cellular base units 121 transmit DL communication signals to serve the remote units 105 in the time, frequency, and/or spatial domain. Furthermore, the DL communication signals may be carried over the 3GPP communication links 123. The 3GPP communication links 123 may be any suitable carrier in licensed or unlicensed radio spectrum. The 3GPP communication links 123 facilitate communication between one or more of the remote units 105 and/or one or more of the cellular base units 121. Note that during NR operation on unlicensed spectrum (referred to as “NR-U”), the base unit 121 and the remote unit 105 communicate over unlicensed (i.e., shared) radio spectrum.

The non-3GPP access networks 130 may be distributed over a geographic region. Each non-3GPP access network 130 may serve a number of remote units 105 with a serving area. An access point 131 in a non-3GPP access network 130 may communicate directly with one or more remote units 105 by receiving UL communication signals and transmitting DL communication signals to serve the remote units 105 in the time, frequency, and/or spatial domain. Both DL and UL communication signals are carried over the non-3GPP communication links 133. The 3GPP communication links 123 and non-3GPP communication links 133 may employ different frequencies and/or different communication protocols. In various embodiments, an access point 131 may communicate using unlicensed radio spectrum. The mobile core network 140 may provide services to a remote unit 105 via the non-3GPP access networks 130, as described in greater detail herein.

In some embodiments, a non-3GPP access network 130 connects to the mobile core network 140 via an interworking entity 135. The interworking entity 135 provides an interworking between the non-3GPP access network 130 and the mobile core network 140. The interworking entity 135 supports connectivity via the “N2” and “N3” interfaces. As depicted, both the 3GPP access network 120 and the interworking entity 135 communicate with the AMF 143 using a “N2” interface. The 3GPP access network 120 and interworking entity 135 also communicate with the UPF 141 using a “N3” interface. While depicted as outside the mobile core network 140, in other embodiments the interworking entity 135 may be a part of the core network. While depicted as outside the non-3GPP RAN 130, in other embodiments the interworking entity 135 may be a part of the non-3GPP RAN 130.

In certain embodiments, a non-3GPP access network 130 may be controlled by an operator of the mobile core network 140 and may have direct access to the mobile core network 140. Such a non-3GPP AN deployment is referred to as a “trusted non-3GPP access network.” A non-3GPP access network 130 is considered as “trusted” when it is operated by the 3GPP operator, or a trusted partner, and supports certain security features, such as strong air-interface encryption. In contrast, a non-3GPP AN deployment that is not controlled by an operator (or trusted partner) of the mobile core network 140, does not have direct access to the mobile core network 140, or does not support the certain security features is referred to as a “non-trusted” non-3GPP access network. An interworking entity 135 deployed in a trusted non-3GPP access network 130 may be referred to herein as a Trusted Network Gateway Function (“TNGF”). An interworking entity 135 deployed in a non-trusted non-3GPP access network 130 may be referred to herein as a non-3GPP interworking function (“N3IWF”). While depicted as a part of the non-3GPP access network 130, in some embodiments the N3IWF may be a part of the mobile core network 140 or may be located in the data network 150.

In one embodiment, the mobile core network 140 is a 5G core (“5GC”) or the evolved packet core (“EPC”), which may be coupled to a data network 150, like the Internet and private data networks, among other data networks. A remote unit 105 may have a subscription or other account with the mobile core network 140. Each mobile core network 140 belongs to a single public land mobile network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF (“UPF”) 141. The mobile core network 140 also includes multiple control plane functions including, but not limited to, an Access and Mobility Management Function (“AMF”) 143 that serves the 5G-RAN 115, a Session Management Function (“SMF”) 145, a Policy Control Function (“PCF”) 146, an Authentication Server Function (“AUSF”) 147, a Unified Data Management (“UDM”) and Unified Data Repository function (“UDR”).

The UPF(s) 141 is responsible for packet routing and forwarding, packet inspection, QoS handling, and external PDU session for interconnecting Data Network (“DN”), in the 5G architecture. The AMF 143 is responsible for termination of NAS signaling, NAS ciphering & integrity protection, registration management, connection management, mobility management, access authentication and authorization, security context management. The SMF 145 is responsible for session management (i.e., session establishment, modification, release), remote unit (i.e., UE) IP address allocation & management, DL data notification, and traffic steering configuration for UPF for proper traffic routing.

The PCF 146 is responsible for unified policy framework, providing policy rules to CP functions, access subscription information for policy decisions in UDR. The AUSF 147 acts as an authentication server.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include an Network Exposure Function (“NEF”) (which is responsible for making network data and resources easily accessible to customers and network partners, e.g., via one or more APIs), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. A network instance may be identified by a S-NSSAI, while a set of network slices for which the remote unit 105 is authorized to use is identified by NSSAI. In certain embodiments, the various network slices may include separate instances of network functions, such as the SMF and UPF 141. In some embodiments, the different network slices may share some common network functions, such as the AMF 143. The different network slices are not shown in FIG. 1 for ease of illustration, but their support is assumed.

Although specific numbers and types of network functions are depicted in FIG. 1, one of skill in the art will recognize that any number and type of network functions may be included in the mobile core network 140. Moreover, where the mobile core network 140 comprises an EPC, the depicted network functions may be replaced with appropriate EPC entities, such as an MME, S-GW, P-GW, HSS, and the like.

While FIG. 1 depicts components of a 5G RAN and a 5G core network, the described embodiments for using a pseudonym for access authentication over non-3GPP access apply to other types of communication networks and RATs, including IEEE 802.11 variants, GSM, GPRS, UMTS, LTE variants, CDMA 2000, Bluetooth, ZigBee, Sigfoxx, and the like. For example, in an 4G/LTE variant involving an EPC, the AMF 143 may be mapped to an MME, the SMF mapped to a control plane portion of a PGW and/or to an MME, the UPF 141 may be mapped to an SGW and a user plane portion of the PGW, the UDM/UDR 149 may be mapped to an HSS, etc.

As depicted, a remote unit 105 (e.g., a UE) may connect to the mobile core network (e.g., to a 5G mobile communication network) via two types of accesses: (1) via 3GPP access network 120 and (2) via a non-3GPP access network 130. The first type of access (e.g., 3GPP access network 120) uses a 3GPP-defined type of wireless communication (e.g., NG-RAN) and the second type of access (e.g., non-3GPP access network 130) uses a non-3GPP-defined type of wireless communication (e.g., WLAN). The 5G-RAN 115 refers to any type of 5G access network that can provide access to the mobile core network 140, including the 3GPP access network 120 and the non-3GPP access network 130.

To solve the problem of establishing a trust-relationship between the application entity and the MnS producer and/or CP to enable access to the MnS implementation and CP services, described above, the present disclosure proposes solutions that establish a trust-relationship between an application entity and the MnS producer and/or CP to enable access to the MnS implementation and CP services using a middleware services that has a trust relationship between the application entity and the MnS/CP.

Beneficially, the proposed solution provides an efficient way to establish a trust relationship between an application entity and an MnS and/or CP to access the MnS and/or CP services for managing its network slice using a commonly-trusted middleware.

A vertical application e.g., an application entity or an application function (AF), may request management services as well as control plane services, e.g., via a middleware service, such as a new slice on demand, based on an agreement between the vertical and the network slice provider. However, the creation of a new slice will require a form of trust between the vertical/end application and the 5GS (e.g., the management and control plane) for authorizing/authenticating the application request and enabling the vertical app to consume management/control services related to the requested slice.

The vertical application/AF, however, may not be trusted by the management service (“MnS”) producer or the control plane (“CP”) and is therefore not able to access CP or management plane (“MP”) services. So, there is an issue as to how to enable the authorization/authentication of the vertical application to consume telco-provided services (e.g., management and control plane services), based on the vertical application's request, which the vertical application/AF may need to directly access the MnS implementation and CP services for managing and controlling its network slice. The subject matter described herein provides a solution for establishing a trust-relationship between the AF and the MnS producer and/or CP to enable access to the MnS implementation and CP services.

As used herein, the vertical application can be provided by an application service provider (“ASP”) and may be an application at the network-side or application client at a user equipment (“UE”) device. Such application includes AF functionality when interacting with the 5GS.

As used herein, a middleware can be defined as a trusted application entity, which provides enablement services to the vertical application for integrating with 5GS. A middleware may include AF functionality when interacting with 5GC.

As described in more detail below, authentication of an application entity (e.g., a vertical application/AF) is performed with the help of a common trusted middleware in the MnS producer and the CP. The authentication utilizes the two trust relationships between the application entity and the middleware as well as the middleware and the MnS producer and/or the CP. The middleware is trusted by both parties. Authentication is performed in the MnS producer by comparing a secret token (e.g., an “authentication password”) directly received from the middleware with the one received from the application entity, including a verification of the CCA token that the trusted middleware was sending the request via the application entity. Authentication is performed in the CP by comparing the secret token directly received from the MnS producer with the one received from the application entity, including a verification of the CCA token that the trusted MnS producer sent the request via the application entity.

As background, in 3GPP SA6, an application support layer is specified for vertical applications, known as vertical application enabler layer (V2X enabler server at TS 23.286, FF enabler server at TR 23.745, UAS enable server at TR 23.755) which acts as a middleware for exposing northbound APIs to vertical applications, as well as to provide some server-client support functionalities for the connected devices. Also, 3GPP SA6 has provided a common for all verticals enabler layer known as SEAL (TS 23.434). SEAL has introduced a new service, namely Network Slice Capability Management, which has a server and client application counterpart. NSCM layer provides a network slice adaptation/migration capability trigger for all devices running an application. This requires interaction between the OAM and NSCM server as well as the NSCM server and the NSCM client at the device side (for applying the slice adaptation).

The middleware in SA6 takes the form of enabler layer which can be SEAL function or a vertical specific enabler function or an edge enabler layer function.

An application entity, as described herein, can be seen as the vertical application which is using the SEAL/enabler layer services. The application entity can be an application server or an application at the UE, which requires the consumption of control and management and/or middleware services. In that case, additional authorization of an application entity is needed to consume CP and MP services, when there is a new service request, which is not covered by the service agreement between the application entity and the telco service provider (e.g., the CP and MP function owner). Such new service request may be, for example, the creation of a new slice or the adaptation of the slice lifecycle (e.g., slice provisioning and/or modification), for accommodating the needs of the vertical customer.

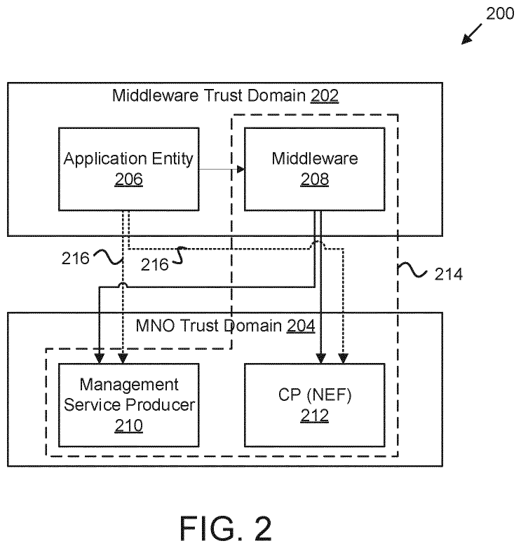

FIG. 2 depicts the trust-relationships between the various entities described above. In one embodiment, FIG. 2 includes a middleware trust domain 202 and an MNO trust domain 204. The middleware trust domain 202 includes an application entity 206 and a middleware 208. The application entity 206 may include an AS, an AF, or an application at a UE, and has an agreement with the middleware 208, e.g., the application entity 206 and the middleware 208 are in the same trust domain 202. The application entity 206 may have a service level agreement with the middleware 206/network operator for requesting a particular network slice. The middleware 208, e.g., a third party application function, is responsible to map the service description from the application entity 206 to a slice description, e.g., to a GSMA slice template, and/or a service/slice profile. The middleware 208 has a trust relationship 214 established between the MnS producer 210 and the CP 212 within the MNO trust domain 204, and vice versa.

The MnS producer 210 is responsible for management within the MNO trust domain 204 including instantiation of the slice requested by the middleware 208, and the CP 212, which may be embodied as a NEF, configures the instantiated slice according to the description in the slice template and/or the service/slice profile. The MnS producer 210 and the CP 212 are in the same trust domain of the MNO 204. As described herein, the application entity 206 may need to establish a trust relationship with the MnS producer 210 and/or the CP 212 to communicate via new application programming interfaces (“APIs”) 216 to request and manage a network slice.

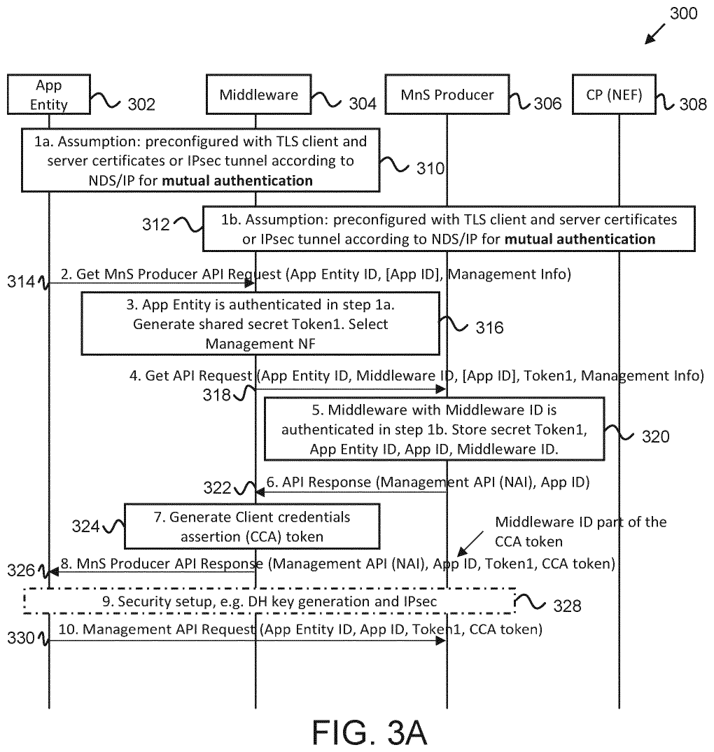

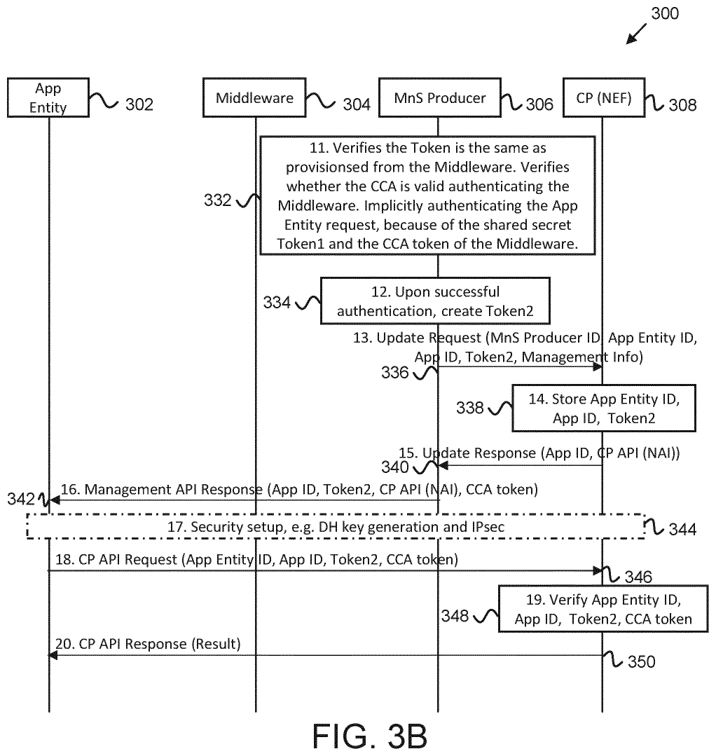

In one embodiment, as depicted in the process flow diagram in FIGS. 3A and 3B, an application entity 302 establishes a trust relationship with an MnS 306 and a CP 308 via a middleware 304. In the depicted embodiment, at step 1a (see block 310), it is assumed that the application entity 302 has a trust relationship with the middleware 304, e.g., based on TLS client-server side certificates or IPsec tunneling for mutual authentication. The communication between the application entity 302 and the middleware 304 is therefore assumed to be ciphered and integrity protected.

At step 1b (see block 312), it is assumed that the middleware has a trust relationship with the MnS producer 306 and/or the CP 308 e.g., based on TLS client-server side certificates or IPsec tunneling for mutual authentication. The communication between the middleware 304 and the MnS producer 306 and/or the CP 308 is therefore assumed to be ciphered and integrity protected.

At step 2, the application entity 302 sends (see messaging 314) an MnS producer API request to the middleware 304, including an identification of the application entity 302 as well as management information for the MnS producer 306 and, if available, an Application ID. If the application entity 302 has no Application ID, it may have to send a service description, which is translated into a slice blueprint in the middleware 304 (e.g., GSMA slice template). This service description may be part of the management information.

At step 3, the middleware 304 authorizes (see block 316) the request and selects an MnS producer 306. The middleware 304 creates a secret token (e.g., token 1), which may be used like a one-time password. Accordingly, the size of the secret token should be sufficiently long enough, e.g., 256 bits, 512 bits, 1024 bits, 2048 bits, or the like. The secret token should be generated in a randomized way such that it is not possible to predict or recreate a future secret token based on previously created tokens.

At step 4, the middleware 304 sends (see messaging 318) an API request to the MnS producer 306, including the middleware ID, Application ID, secret token (e.g., token 1) and the management information. If no Application ID is included in the request, the management information contains information about the requested slice (e.g., GSMA slice template).

At step 5, the MnS producer 306 authorizes (see block 320) the request from the middleware 304 and stores the middleware ID, Application ID, and secret token together. If the request did not contain an Application ID, the MnS producer 306 will generate a unique, at least within the MnS producer 306, Application ID for the slice description and the application entity ID. The MnS producer may generate a network slice selection assistance information (“NSSAI”) in addition to or in place of the Application ID.

At step 6, the MnS producer 306 sends (see messaging 322) an API response to the middleware 304, including the Application ID (e.g., the NSSAI) and the network address identifier (“NAI”) of the management API, e.g., AppID@management.mno.com. The NAI may be generic for all application entities 302 or specific to a particular application entity 302.

At step 7, upon reception of the API Response, the middleware 304 generates (see block 324) a client credential assertion (“CCA”) token, e.g., according to TS 33.501.

At step 8, the middleware 304 sends (see messaging 326) an MnS API response to the application entity 302, which may include the NAI of the management API, the Application ID (e.g., the NSSAI), the secret token (token 1) and the CCA token.

At step 9, the application entity 302 may setup (see block 328) a security association with the MnS producer 306, e.g., with a Diffie-Hellman (“DH”) key generation and a TLS/IPSec setup.

At step 10, the application entity 302 sends (see messaging 330) a management API request directly to the management API using the NAI. The request may contain the application entity ID, Application ID (e.g., the NSSAI), the secret token (token 1) and the CCA token of the middleware 304.

At step 11, shown in FIG. 3B, the MnS producer 306 verifies (see block 332) that the CCA token is signed by the middleware 304 and compares the Application ID (e.g., the NSSAI) and the secret token (token 1) with the tokens that were received and stored in step 5. If the tokens match, then the MnS producer 306 indirectly authenticates the application entity 302 because the middleware 304 created the secret token (token 1) and it should not be known to any other function except the MnS producer 306. Further the CCA token from the middleware 304 that is sent via the application entity 302, including the secret token (token 1), shows that the request is genuinely coming from the trusted middleware 304 with the secret token (token 1), which is used as a one-time password for the authentication. Note that in step 1b, as described above, it is assumed that a cross-certification process is established between the middleware 304 and the MnS producer 306 to verify the certificates.

At step 12, upon successful authentication of the application entity 302, the MnS producer 306 generates (see block 334) a new secret token (token 2), which is used as a one-time password. Accordingly, the size of the secret token should be sufficiently long enough, e.g., 256 bits, 512 bits, 1024 bits, 2048 bits, or the like. The secret token should be generated in a randomized way such that it is not possible to predict or recreate a future secret token based on previously created tokens.

At step 13, the MnS producer sends (see messaging 336) an update request to the CP 308, which may include the MnS producer ID, application entity ID, Application ID (e.g., the NSSAI) and the secret token (token 2), as well as CP management information.

At step 14, the CP 308 stores (see block 338) the application entity ID, Application ID (e.g., the NSSAI) and the secret token (token 2) for authentication of a later request from the application entity 302.

At step 15, the CP 308 sends (see messaging 340) an update response to the MnS producer 306, including the NAI of the CP API, e.g., AppID@nef.mno.com. The NAI may be generic for all application entities 302 or specific to a particular application entity 302.

At step 16, upon reception of the update response, the MnS producer 306 generates a CCA token, e.g., according to TS 33.501. The MnS producer sends (see messaging 342) a management API response to the application entity 302, which may include the NAI of the CP API, the Application ID (e.g., the NSSAI), the CCA token, and the secret token (token 2).

At step 17, the application entity 302 may setup (see block 344) a security association with the CP 308, e.g., with a DH key generation and a TLS/IPSec setup.

At step 18, the application entity 302 sends (see messaging 346) a CP API request directly to the CP API using the NAI. The request may contain the application entity ID, Application ID (e.g., the NSSAI), the CCA token, and the secret token (token 2).

At step 19, the CP 308 verifies (see block 348) that the request comes from the application entity 302 by comparing the application entity ID, Application ID (e.g., the NSSAI) and the secret token (token 2) with the tokens stored in step 13. If the tokens match, then the CP 308 indirectly authenticates the application entity 302 because the MnS producer 306 created the secret token (token 2), and it should not be known to any other function except the CP 308. Further, the CP 308 verifies that the CCA is signed by the MnS producer 306. The CCA token from the MnS producer 306 that is sent via the application entity 302, including the secret token (token 2), shows that the request is genuinely coming from the trusted MnS producer with the secret token (token 2), which is used as a one-time password for the authentication.

At step 20, the CP 308 sends (see messaging 350) a CP API response to the application entity 302 with the result of the authentication. The application entity 302 can now send messages to the MnS producer 306 and the CP 308.

In another embodiment, the middleware 304 does not create and send a secret token to the MnS producer 306. Instead, only the CCA token is used to verify in the MnS producer 306 that the request is coming from the middleware 304 via the application entity 302 and the Application ID (e.g., the NSSAI) is used to correlate to the previous request from the middleware 304 to the MnS producer 306.

In another embodiment, the MnS producer 306 does not create and send a secret token to the CP 304. Instead, only the CCA token is used to verify in the CP 308 that the request is coming from the MnS producer 306 via the application entity and the Application ID (e.g., the NSSAI) is used to correlate to the previous request from the MnS producer 306 to the CP 308.

In another embodiment, the first secret token (token 1) is created by the application entity 302 instead of the middleware 304 and sent in the first message to the middleware 304 (e.g., in step 2). In another embodiment, neither the middleware 304 nor the MnS producer 306 creates a secret token.

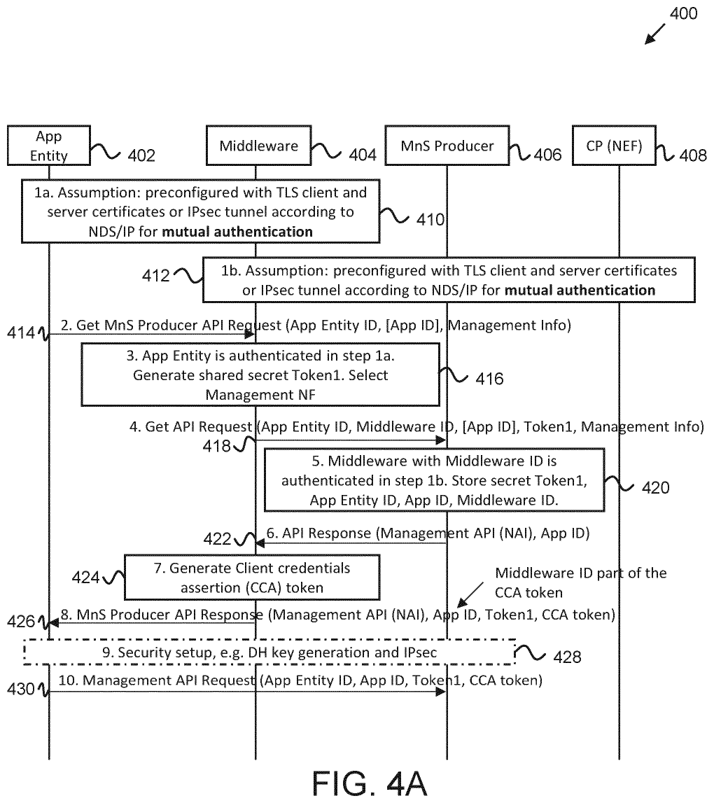

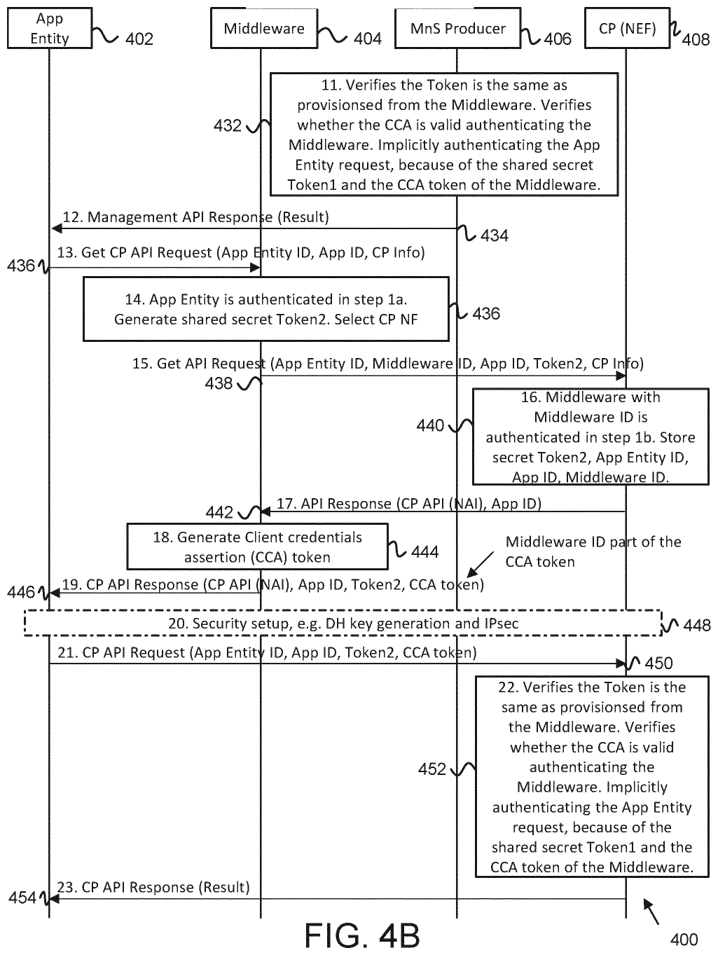

In another embodiment, the authentication in the CP 308 is performed via the middleware 304 instead of the MnS producer 306, e.g., the application entity 302 sends a CP API request to the middleware 304, and the middleware 306 creates a secret token (token 2) such that the middleware CCA token is used towards the CP 308, as shown below in FIGS. 4A-4B.

In one embodiment, as depicted in the process flow diagram in FIGS. 3A and 3B, an application entity 402 establishes a trust relationship with an MnS 406 and a CP 408 via a middleware 404. In the depicted embodiment, at step 1a (see block 410), it is assumed that the application entity 402 has a trust relationship with the middleware 404, e.g., based on TLS client-server side certificates or IPsec tunneling for mutual authentication. The communication between the application entity 402 and the middleware 404 is therefore assumed to be ciphered and integrity protected.

At step 1b (see block 412), it is assumed that the middleware has a trust relationship with the MnS producer 406 and/or the CP 408 e.g., based on TLS client-server side certificates or IPsec tunneling for mutual authentication. The communication between the middleware 404 and the MnS producer 406 and/or the CP 408 is therefore assumed to be ciphered and integrity protected.

At step 2, the application entity 402 sends (see messaging 414) an MnS producer API request to the middleware 404, including an identification of the application entity 402 as well as management information for the MnS producer 406 and, if available, an Application ID. If the application entity 402 has no Application ID, it may have to send a service description, which is translated into a slice blueprint in the middleware 404 (e.g., GSMA slice template). This service description may be part of the management information.

At step 3, the middleware 404 authorizes (see block 416) the request and selects an MnS producer 406. The middleware 404 creates a secret token (e.g., token 1), which may be used like a one-time password. Accordingly, the size of the secret token should be sufficiently long enough, e.g., 256 bits, 512 bits, 1024 bits, 2048 bits, or the like. The secret token should be generated in a randomized way such that it is not possible to predict or recreate a future secret token based on previously created tokens.

At step 4, the middleware 404 sends (see messaging 418) an API request to the MnS producer 406, including the middleware ID, Application ID, secret token (e.g., token 1) and the management information. If no Application ID is included in the request, the management information contains information about the requested slice (e.g., GSMA slice template).

At step 5, the MnS producer 406 authorizes (see block 420) the request from the middleware 404 and stores the middleware ID, Application ID, and secret token together. If the request did not contain an Application ID, the MnS producer 406 will generate a unique, at least within the MnS producer 406, Application ID for the slice description and the application entity ID. The MnS producer may generate a network slice selection assistance information (“NSSAI”) in addition to or in place of the Application ID.

At step 6, the MnS producer 406 sends (see messaging 422) an API response to the middleware 404, including the Application ID (e.g., the NSSAI) and the network address identifier (“NAI”) of the management API, e.g., AppID@management.mno.com. The NAI may be generic for all application entities 402 or specific to a particular application entity 402.

At step 7, upon reception of the API Response, the middleware 404 generates (see block 424) a client credential assertion (“CCA”) token, e.g., according to TS 33.501.

At step 8, the middleware 404 sends (see messaging 426) an MnS API response to the application entity 402, which may include the NAI of the management API, the Application ID (e.g., the NSSAI), the secret token (token 1) and the CCA token.

At step 9, the application entity 402 may setup (see block 428) a security association with the MnS producer 406, e.g., with a Diffie-Hellman (“DH”) key generation and a TLS/IPSec setup.

At step 10, the application entity 402 sends (see messaging 430) a management API request directly to the management API using the NAI. The request may contain the application entity ID, Application ID (e.g., the NSSAI), the secret token (token 1) and the CCA token of the middleware 404.

At step 11, shown in FIG. 4B, the MnS producer 406 verifies (see block 432) that the CCA token is signed by the middleware 404 and compares the Application ID (e.g., the NSSAI) and the secret token (token 1) with the tokens that were received and stored in step 5. If the tokens match, then the MnS producer 406 indirectly authenticates the application entity 402 because the middleware 404 created the secret token (token 1) and it should not be known to any other function except the MnS producer 406. Further the CCA token from the middleware 404 that is sent via the application entity 402, including the secret token (token 1), shows that the request is genuinely coming from the trusted middleware 404 with the secret token (token 1), which is used as a one-time password for the authentication. Note that in step 1b, as described above, it is assumed that a cross-certification process is established between the middleware 404 and the MnS producer 406 to verify the certificates.

At step 12, the MnS producer 406 sends (see messaging 434) a Management API Response to the application entity 402 with the result of the authentication. The application entity 402 can now send messages to the MnS producer 406.

At step 13, the application entity 402 sends (see messaging 436) an CP API Request to the middleware 404, including an identification of the application entity 402 as well as management information for the MnS producer 406 and the Application ID (e.g., the NSSAI).

At step 14, the middleware 404 authorizes (see block 436) the request and selects a CP 408. The middleware 404 creates a secret token (token 2), which may be used like a one-time password. Accordingly, the size of the secret token should be sufficiently long enough, e.g., 256 bits, 512 bits, 1024 bits, 2048 bits, or the like. The secret token should be generated in a randomized way such that it is not possible to predict or recreate a future secret token based on previously created tokens.

At step 15, the middleware 404 sends (see messaging 438) an API Request to the CP 408, including the middleware ID, Application ID (e.g., the NSSAI), the secret token (token 2), and the management information.

At step 16, the CP 308 authorizes (see messaging 440) the request from the middleware 404 and stores the middleware ID, Application ID (e.g., the NSSAI) and the secret token (token 2) together.

At step 17, the CP 308 sends (see messaging 442) an API response to the middleware 404, including the Application ID (e.g., the NSSAI) and the NAI of the CP API, e.g., AppID@nef.mno.com. The NAI may be generic for all application entities 402 or specific to a particular application entity 402.

At step 18, upon reception of the API Response, the middleware 404 generates (see block 444) a CCA token, e.g., according to TS 33.501.

At step 19, the middleware 404 sends (see messaging 446) an API Response to the application entity 402, which may include the NAI of the CP API, the Application ID (e.g., the NSSAI), the secret token (token 2), and the CCA token.

At step 20, the application entity 402 may setup (see block 448) a security association with the CP, e.g., with a DH key generation and a TLS/IPSec setup.

At step 21, the application entity 402 sends (see messaging 450) a CP API Request directly to the CP API using the NAI. The request may contain the application entity ID, Application ID (e.g., the NSSAI), the secret token (token 2), and the CCA token of the middleware 404.

At step 22, the CP 408 verifies (see block 452) that the CCA is signed by the middleware 404 and compares the Application ID (e.g., the NSSAI) and the secret token (token 2) with the tokens stored in step 5. If the tokens match, then the CP 408 indirectly authenticates the application entity 402, because the middleware 404 created the secret token (token 2) and it should not be known to any other function as the CP 408 and the application entity 402. Further, the CCA token from the middleware 404, that is sent via the application entity 402, which may also include the secret token (token 2), shows that the request is genuinely coming from the trusted middleware 404 with the secret token (token 2), which is used as a one-time password for the authentication. Note that in step 1b it is assumed that a cross-certification process is established between the middleware 404 and the CP 408 to verify the certificates.

At step 23, the CP 408 sends (see messaging 454) a CP API Response to the application entity 402 with the result of the authentication. The application entity 402 can now send messages to the MnS producer 406 and the CP 408.

In another embodiment, the middleware 404 does not create and send a secret token to the CP 408; instead, only the CCA token is used to verify in the CP 408 that the request is coming from the middleware 404 via the application entity 402 and the Application ID (e.g., the NSSAI) is used to correlate to the previous request from the middleware 404 to the CP 408.

In another embodiment, the first secret token (token 1) is created by the application entity 402 instead of the middleware 404 and sent in the first message to the middleware 404 (step 2).

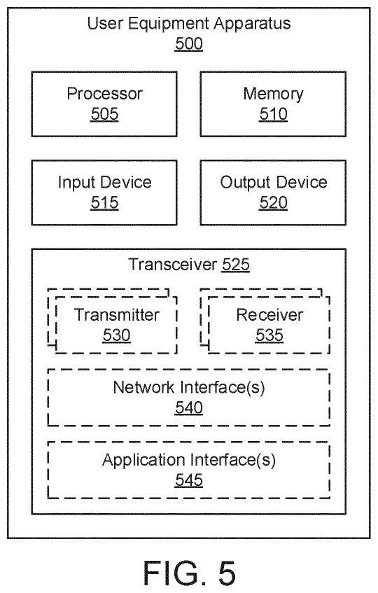

FIG. 5 depicts a user equipment apparatus 500 that may be used for establishing a trust relationship between an application entity and a wireless communication network, according to embodiments of the disclosure. In various embodiments, the user equipment 20) apparatus 500 is used to implement one or more of the solutions described above. The user equipment apparatus 500 may be one embodiment of the remote unit 105 and/or the UE 205, described above. Furthermore, the user equipment apparatus 500 may include a processor 505, a memory 510, an input device 515, an output device 520, and a transceiver 525.

In some embodiments, the input device 515 and the output device 520 are combined into a single device, such as a touchscreen. In certain embodiments, the user equipment apparatus 500 may not include any input device 515 and/or output device 520. In various embodiments, the user equipment apparatus 500 may include one or more of: the processor 505, the memory 510, and the transceiver 525, and may not include the input device 515 and/or the output device 520.

As depicted, the transceiver 525 includes at least one transmitter 530 and at least one receiver 535. In some embodiments, the transceiver 525 communicates with one or more cells (or wireless coverage areas) supported by one or more base units 121. In various embodiments, the transceiver 525 is operable on unlicensed spectrum. Moreover, the transceiver 525 may include multiple UE panel supporting one or more beams. Additionally, the transceiver 525 may support at least one network interface 540 and/or application interface 545. The application interface(s) 545 may support one or more APIs. The network interface(s) 540 may support 3GPP reference points, such as Uu, N1, PC5, etc. Other network interfaces 540 may be supported, as understood by one of ordinary skill in the art.

The processor 505, in one embodiment, may include any known controller capable of executing computer-readable instructions and/or capable of performing logical operations. For example, the processor 505 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 505 executes instructions stored in the memory 510 to perform the methods and routines described herein. The processor 505 is communicatively coupled to the memory 510, the input device 515, the output device 520, and the transceiver 525. In certain embodiments, the processor 505 may include an application processor (also known as “main processor”) which manages application-domain and operating system (“OS”) functions and a baseband processor (also known as “baseband radio processor”) which manages radio functions.

In various embodiments, the processor 505 controls the user equipment apparatus 500 to implement the above described UE behaviors. For example, the transceiver 525 sends, from an application entity, a request to a first network function to authenticate the application entity to a second network function that does not have a trust relationship with the application entity.

In one embodiment, a transceiver 525 receives a result of the authentication from at least one of the first and second network functions and a processor 505 establishes a trust relationship between the application entity and the second network function such that the application entity can communicate with the second network function in response to the application entity being authenticated.

In one embodiment, a transceiver 525 receives, from the first network function, a network address identifier (“NAI”) of the second network function, and a client credential assertion (“CCA”) token associated with the first network function. In one embodiment, a processor 505 establishes a security association between the application entity and the second network function for sending a management message to the second network function.

In one embodiment, a transceiver 525 sends, from the application entity, the management message to the second network function using the NAI of the second network function. In one embodiment, a transceiver 525 sends a first secret token to the second network function and further receiving the second secret token, the NAI of the third network function, and the CCA token associated with the second network function in response to the first secret token being verified.

In one embodiment, a processor 505 generates the first secret token at the application entity. In one embodiment, the first apparatus includes establishing a security association between the application entity and the third network function for sending a management message to the third network function.

In one embodiment, a transceiver 525 sends, from the application entity, a management message to a third network function using the NAI of the third network function. In some embodiments, a transceiver 525 sends a second secret token to the third network function and further receiving the authentication result in response to the second secret token being verified. In one embodiment, a processor 505 determines application entity information for the application entity.

The memory 510, in one embodiment, is a computer readable storage medium. In some embodiments, the memory 510 includes volatile computer storage media. For example, the memory 510 may include a RAM, including dynamic RAM (“DRAM”), synchronous dynamic RAM (“SDRAM”), and/or static RAM (“SRAM”). In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media.

In some embodiments, the memory 510 stores data related to establishing a trust relationship between an application entity and a wireless communication network. For example, the memory 510 may store various parameters, panel/beam configurations, resource assignments, policies, and the like, as described above. In certain embodiments, the memory 510 also stores program code and related data, such as an operating system or other controller algorithms operating on the user equipment apparatus 500.

The input device 515, in one embodiment, may include any known computer input device including a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, is designed to output visual, audible, and/or haptic signals. In some embodiments, the output device 520 includes an electronically controllable display or display device capable of outputting visual data to a user. For example, the output device 520 may include, but is not limited to, an LCD display, an LED display, an OLED display, a projector, or similar display device capable of outputting images, text, or the like to a user. As another, non-limiting, example, the output device 520 may include a wearable display separate from, but communicatively coupled to, the rest of the user equipment apparatus 500, such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime). In some embodiments, the output device 520 includes one or more haptic devices for producing vibrations, motion, or other haptic feedback. In some embodiments, all, or portions of the output device 520 may be integrated with the input device 515. For example, the input device 515 and output device 520 may form a touchscreen or similar touch-sensitive display. In other embodiments, the output device 520 may be located near the input device 515.

The transceiver 525 communicates with one or more network functions of a mobile communication network via one or more access networks. The transceiver 525 operates under the control of the processor 505 to transmit messages, data, and other signals and also to receive messages, data, and other signals. For example, the processor 505 may selectively activate the transceiver 525 (or portions thereof) at particular times in order to send and receive messages.

The transceiver 525 includes at least transmitter 530 and at least one receiver 535. One or more transmitters 530 may be used to provide UL communication signals to a base unit 121, such as the UL transmissions described herein. Similarly, one or more receivers 535 may be used to receive DL communication signals from the base unit 121, as described herein. Although only one transmitter 530 and one receiver 535 are illustrated, the user equipment apparatus 500 may have any suitable number of transmitters 530 and receivers 535. Further, the transmitter(s) 530 and the receiver(s) 535 may be any suitable type of transmitters and receivers. In one embodiment, the transceiver 525 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 525, transmitters 530, and receivers 535 may be implemented as physically separate components that access a shared hardware resource and/or software resource, such as for example, the network interface 540.

In various embodiments, one or more transmitters 530 and/or one or more receivers 535 may be implemented and/or integrated into a single hardware component, such as a multi-transceiver chip, a system-on-a-chip, an ASIC, or other type of hardware component. In certain embodiments, one or more transmitters 530 and/or one or more receivers 535 may be implemented and/or integrated into a multi-chip module. In some embodiments, other components such as the network interface 540 or other hardware components/circuits may be integrated with any number of transmitters 530 and/or receivers 535 into a single chip. In such embodiment, the transmitters 530 and receivers 535 may be logically configured as a transceiver 525 that uses one more common control signals or as modular transmitters 530 and receivers 535 implemented in the same hardware chip or in a multi-chip module.

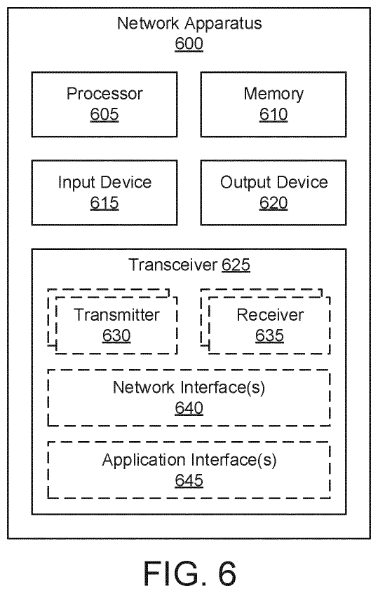

FIG. 6 depicts a network apparatus 600 that may be used for establishing a trust relationship between an application entity and a wireless communication network, according to embodiments of the disclosure. In one embodiment, network apparatus 600 may be one implementation of a RAN node, such as the base unit 121, the RAN node 210, or gNB, described above. Furthermore, the base network apparatus 600 may include a processor 605, a memory 610, an input device 615, an output device 620, and a transceiver 625.

In some embodiments, the input device 615 and the output device 620 are combined into a single device, such as a touchscreen. In certain embodiments, the network apparatus 600 may not include any input device 615 and/or output device 620. In various embodiments, the network apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. Here, the transceiver 625 communicates with one or more remote units 105. Additionally, the transceiver 625 may support at least one network interface 640 and/or application interface 645. The application interface(s) 645 may support one or more APIs. The network interface(s) 640 may support 3GPP reference points, such as Uu, N1, N2 and N3. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a CPU, a GPU, an auxiliary processing unit, a FPGA, or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625. In certain embodiments, the processor 805 may include an application processor (also known as “main processor”) which manages application-domain and operating system (“OS”) functions and a baseband processor (also known as “baseband radio processor”) which manages radio function.

In various embodiments, the network apparatus 600 is a middleware, MnS, or a CP, described above. In such embodiments, the processor 605 generates, at a first network function, a client credential assertion (“CCA”) token for the first network function.

In one embodiment, a transceiver 625 sends, from the first network function, an authentication request to a second network function for authenticating an application entity. In some embodiments, a transceiver 625 receives, at the first network function from the second network function, a response to the authentication request comprising a network address identifier (“NAI”) for the second network function.

In one embodiment, a transceiver 625 sends, from the first network function to the application entity, the response to the authentication request comprising the NAI for the second network function and the CCA token of the first network function for establishing a security association between the application entity and the second network function.

In one embodiment, a processor 605 that determines a first secret token at the first network function in response to a request to authenticate the application entity to the second network function that has a trust relationship with the first network function and does not have a trust relationship with the application entity.

In one embodiment, a transceiver 625 that sends information about a requested slice associated with the application entity based on a service description associated with the application entity.

In one embodiment, a transceiver 625 receives, at a first network function, an authentication request from an application entity that does not have a trust relationship with the first network function. In some embodiments, a processor 605 verifies, at the first network function, that the CCA token is associated with the second network function.

In various embodiments, a transceiver 625 sends, from the first network function to the application entity, an authentication result in response to verifying the CCA token. In one embodiment, a transceiver 625 receives, at the first network function, a first secret token in the authentication request and authenticating the application entity in response to the received first secret token matching a first secret token that is previously-received from the second network function.

In various embodiments, a transceiver 625 receives, at the first network function, an application identifier for the application entity in the authentication request and authenticating the application entity in response to the received application identifier matching an application identifier that is previously-received from the second network function.

In one embodiment, in response to authenticating the application entity, a transceiver 625 sends, from the first network function, the application identifier and an application entity identifier to the third network function for use in authenticating the application entity with the third network function.

In one embodiment, a processor 605 generates, at the first network function, a second secret token at the first network function and sending the second secret token to the third network function for use in authenticating the application entity with the third network function.

In one embodiment, a transceiver 625 sends, from the first network function, the second secret token to the application entity for use in authenticating the application entity with the third network function.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to establishing a trust relationship between an application entity and a wireless communication network. For example, the memory 610 may store parameters, configurations, resource assignments, policies, and the like, as described above. In certain embodiments, the memory 610 also stores program code and related data, such as an operating system or other controller algorithms operating on the network apparatus 600.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, an LCD display, an LED display, an OLED display, a projector, or similar display device capable of outputting images, text, or the like to a user. As another, non-limiting, example, the output device 620 may include a wearable display separate from, but communicatively coupled to, the rest of the network apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all, or portions of the output device 620 may be integrated with the input device 615. For example, the input device 615 and output device 620 may form a touchscreen or similar touch-sensitive display. In other embodiments, the output device 620 may be located near the input device 615.

The transceiver 625 includes at least transmitter 630 and at least one receiver 635. One or more transmitters 630 may be used to communicate with the UE, as described herein. Similarly, one or more receivers 635 may be used to communicate with network functions in the NPN, PLMN and/or RAN, as described herein. Although only one transmitter 630 and one receiver 635 are illustrated, the network apparatus 600 may have any suitable number of transmitters 630 and receivers 635. Further, the transmitter(s) 630 and the receiver(s) 635 may be any suitable type of transmitters and receivers.

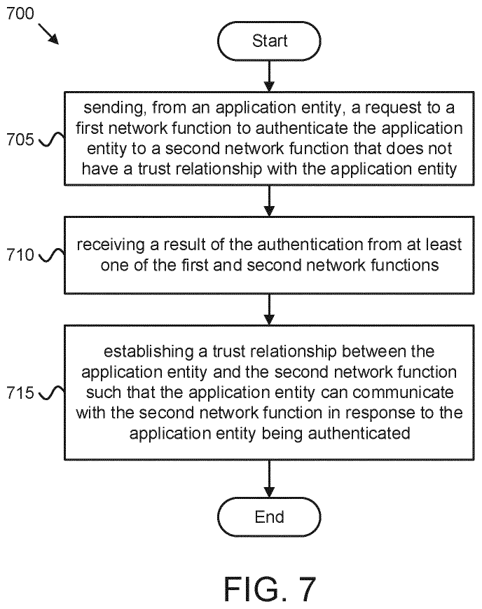

FIG. 7 is a flowchart diagram of a method 700 for establishing a trust relationship between an application entity and a wireless communication network. The method 700 may be performed by an application entity locate on a UE as described herein, for example, the remote unit 105, the UE 205 and/or the user equipment apparatus 500 and/or a network device such as the network apparatus 600. In some embodiments, the method 700 may be performed by a processor executing program code, for example, a microcontroller, a microprocessor, a CPU, a GPU, an auxiliary processing unit, a FPGA, or the like.

The method 700, in one embodiment, includes sending 705, from an application entity, a request to a first network function to authenticate the application entity to a second network function that does not have a trust relationship with the application entity.

In some embodiments, the method 700 includes receiving 710 a result of the authentication from at least one of the first and second network functions. In various embodiments, the method 700 includes establishing 715 a trust relationship between the application entity and the second network function such that the application entity can communicate with the second network function in response to the application entity being authenticated. The method 700 ends.

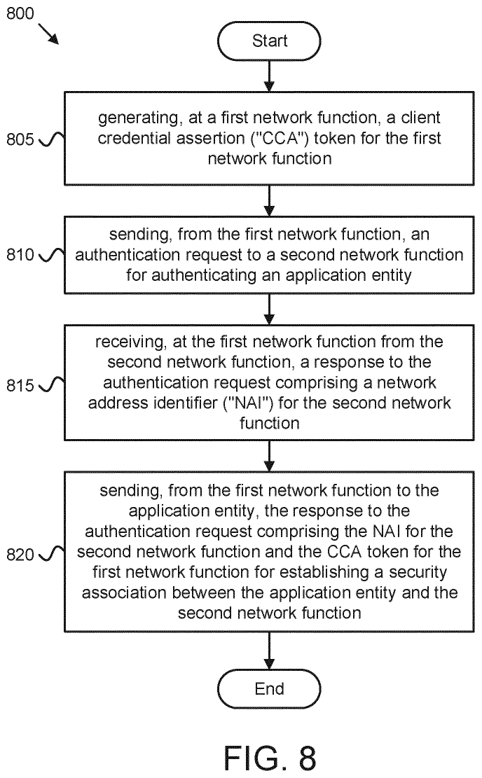

FIG. 8 is a flowchart diagram of a method 800 for establishing a trust relationship between an application entity and a wireless communication network. The method 800 may be performed by a network function located on a network device such as the network apparatus 600. In some embodiments, the method 800 may be performed by a processor executing program code, for example, a microcontroller, a microprocessor, a CPU, a GPU, an auxiliary processing unit, a FPGA, or the like.

In one embodiment, the method 800 includes generating 805, at a first network function, a client credential assertion (“CCA”) token for the first network function. In various embodiments, the method 800 includes sending 810, from the first network function, an authentication request to a second network function for authenticating an application entity.

In one embodiment, the method 800 includes receiving 815, at the first network function from the second network function, a response to the authentication request comprising a network address identifier (“NAI”) for the second network function. In certain embodiments, the method 800 includes sending 820, from the first network function to the application entity, the response to the authentication request comprising the NAI for the second network function and the CCA token of the first network function for establishing a security association between the application entity and the second network function. The method 800 ends.

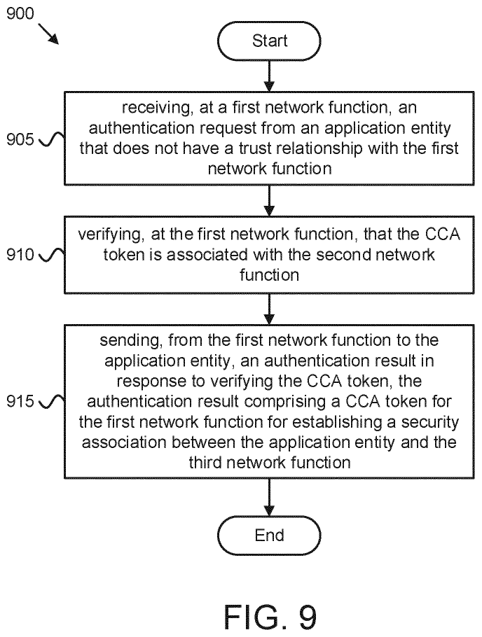

FIG. 9 is a flowchart diagram of a method 900 for establishing a trust relationship between an application entity and a wireless communication network. The method 900 may be performed by a network function located on a network device such as the network apparatus 600. In some embodiments, the method 900 may be performed by a processor executing program code, for example, a microcontroller, a microprocessor, a CPU, a GPU, an auxiliary processing unit, a FPGA, or the like.

In one embodiment, the method 900 includes receiving, at a first network function, an authentication request from an application entity that does not have a trust relationship with the first network function. In further embodiments, the method 900 includes verifying, at the first network function, that the CCA token is associated with the second network function. In certain embodiments, the method 900 includes sending, from the first network function to the application entity, an authentication result in response to verifying the CCA token, the authentication result comprising a CCA token of the first network function for establishing a security association between the application entity and the third network function. The method 900 ends.

In one embodiment, a first method is disclosed for establishing a trust relationship between an application entity and a wireless communication network. The first method may be performed by an application entity on a UE device, such as the user equipment apparatus 500 and/or a network device such as the network apparatus 600. In one embodiment, the first method includes sending, from an application entity, a request to a first network function to authenticate the application entity to a second network function that does not have a trust relationship with the application entity. The first network function may have a trust relationship with the application entity and the second network function. The request may include at least one verifiable parameter for authenticating the application entity.

In certain embodiments, the first method includes receiving a result of the authentication from at least one of the first and second network functions and establishing a trust relationship between the application entity and the second network function such that the application entity can communicate with the second network function in response to the application entity being authenticated.

In one embodiment, the first method includes receiving, from the first network function, a network address identifier (“NAI”) of the second network function, and a client credential assertion (“CCA”) token associated with the first network function.

In one embodiment, the first method includes establishing a security association between the application entity and the second network function for sending a management message to the second network function.

In some embodiments, the first method includes sending, from the application entity, the management message to the second network function using the NAI of the second network function, the second management message comprising an application entity identifier, an application identifier, and the CCA token of the first network function and receiving, from the second network function, a second secret token, an NAI of a third network function, and a CCA token associated with the second network function in response to the CCA token associated with the first network function being verified.

In one embodiment, the first method includes sending a first secret token to the second network function and further receiving the second secret token, the NAI of the third network function, and the CCA token associated with the second network function in response to the first secret token being verified.

In one embodiment, the first method includes generating the first secret token at the application entity. In one embodiment, the first method includes establishing a security association between the application entity and the third network function for sending a management message to the third network function.

In one embodiment, the first method includes sending, from the application entity, a management message to a third network function using the NAI of the third network function, the third management message comprising the application entity identifier, the application identifier, and the CCA token of the second network function and receiving, from the third network function, the result of authenticating the application entity in response to the CCA token associated with the second network function being verified at the third network function.

In one embodiment, the first method includes sending a second secret token to the third network function and further receiving the authentication result in response to the second secret token being verified. In certain embodiments, the first method includes determining application entity information for the application entity, the application entity information comprising at least one of an application entity identifier, an application identifier, and management information for authenticating the application entity with a mobile wireless communication network.

In one embodiment, the management information comprises a service description associated with the application entity, the service description translated into a slice blueprint at the second network function to derive the application identifier.

In one embodiment, a first apparatus is disclosed for establishing a trust relationship between an application entity and a wireless communication network. The first apparatus may be embodied as an application entity of a UE device, such as the user equipment apparatus 500 and/or a network device such as the network apparatus 600. In one embodiment, the first apparatus includes a transceiver that sends, from an application entity, a request to a first network function to authenticate the application entity to a second network function that does not have a trust relationship with the application entity. The first network function may have a trust relationship with the application entity and the second network function. The request may include at least one verifiable parameter for authenticating the application entity.

In certain embodiments, the first apparatus includes a transceiver that receives a result of the authentication from at least one of the first and second network functions and a processor that establishes a trust relationship between the application entity and the second network function such that the application entity can communicate with the second network function in response to the application entity being authenticated.

In one embodiment, the first apparatus includes a transceiver that receives, from the first network function, a network address identifier (“NAI”) of the second network function, and a client credential assertion (“CCA”) token associated with the first network function.

In one embodiment, the first apparatus includes a processor that establishes a security association between the application entity and the second network function for sending a management message to the second network function.

In some embodiments, the first apparatus includes a transceiver that sends, from the application entity, the management message to the second network function using the NAI of the second network function, the second management message comprising an application entity identifier, an application identifier, and the CCA token of the first network function and receiving, from the second network function, a second secret token, an NAI of a third network function, and a CCA token associated with the second network function in response to the CCA token associated with the first network function being verified.

In one embodiment, the first apparatus includes a transceiver that sends a first secret token to the second network function and further receiving the second secret token, the NAI of the third network function, and the CCA token associated with the second network function in response to the first secret token being verified.

In one embodiment, the first apparatus includes a processor that generates the first secret token at the application entity. In one embodiment, the first apparatus includes establishing a security association between the application entity and the third network function for sending a management message to the third network function.

In one embodiment, the first apparatus includes a transceiver that sends, from the application entity, a management message to a third network function using the NAI of the third network function, the third management message comprising the application entity identifier, the application identifier, and the CCA token of the second network function and receiving, from the third network function, the result of authenticating the application entity in response to the CCA token associated with the second network function being verified at the third network function.

In one embodiment, the first apparatus includes a transceiver that sends a second secret token to the third network function and further receiving the authentication result in response to the second secret token being verified. In certain embodiments, the first apparatus includes a processor that determines application entity information for the application entity, the application entity information comprising at least one of an application entity identifier, an application identifier, and management information for authenticating the application entity with a mobile wireless communication network.

In one embodiment, the management information comprises a service description associated with the application entity, the service description translated into a slice blueprint at the second network function to derive the application identifier.

In one embodiment, a second method is disclosed for establishing a trust relationship between an application entity and a wireless communication network. The second method may be performed by a network function, e.g., a middleware, of a network device such as the network apparatus 600. In one embodiment, the second method includes generating, at a first network function, a client credential assertion (“CCA”) token for the first network function.

In further embodiments, the second method includes sending, from the first network function, an authentication request to a second network function for authenticating an application entity, the authentication request comprising the CCA token of the first network function, the application entity having a trust relationship with the first network function and not the second network function.

In one embodiment, the second method includes receiving, at the first network function from the second network function, a response to the authentication request comprising a network address identifier (“NAI”) for the second network function.

In one embodiment, the second method includes sending, from the first network function to the application entity, the response to the authentication request comprising the NAI for the second network function and the CCA token of the first network function for establishing a security association between the application entity and the second network function.

In one embodiment, the second method includes determining a first secret token at the first network function in response to a request to authenticate the application entity to the second network function that has a trust relationship with the first network function and does not have a trust relationship with the application entity.

In one embodiment, the first secret token is received from the application entity, the application entity creating the first secret token and sending it to the first network function. In some embodiments, the first network function creates the first secret token and sends it to the application entity. In some embodiments, the authentication request further comprises the first secret token, an identifier for the first network function, and an application identifier for the application entity for verifying the authentication request and authenticating the application entity.

In one embodiment, the second method includes sending information about a requested slice associated with the application entity based on a service description associated with the application entity.

In one embodiment, a second apparatus is disclosed for establishing a trust relationship between an application entity and a wireless communication network. The second apparatus may be embodied as a network function, e.g., a middleware, of a network device such as the network apparatus 600. In one embodiment, the second apparatus includes a processor that generates, at a first network function, a client credential assertion (“CCA”) token for the first network function.

In further embodiments, the second apparatus includes a transceiver that sends, from the first network function, an authentication request to a second network function for authenticating an application entity, the authentication request comprising the CCA token of the first network function, the application entity having a trust relationship with the first network function and not the second network function.

In one embodiment, the second apparatus includes a transceiver that receives, at the first network function from the second network function, a response to the authentication request comprising a network address identifier (“NAI”) for the second network function.

In one embodiment, the second apparatus includes a transceiver that sends, from the first network function to the application entity, the response to the authentication request comprising the NAI for the second network function and the CCA token of the first network function for establishing a security association between the application entity and the second network function.

In one embodiment, the second apparatus includes a processor that determines a first secret token at the first network function in response to a request to authenticate the application entity to the second network function that has a trust relationship with the first network function and does not have a trust relationship with the application entity.

In one embodiment, the first secret token is received from the application entity, the application entity creating the first secret token and sending it to the first network function. In some embodiments, the first network function creates the first secret token and sends it to the application entity. In some embodiments, the authentication request further comprises the first secret token, an identifier for the first network function, and an application identifier for the application entity for verifying the authentication request and authenticating the application entity.

In one embodiment, the second apparatus includes a transceiver that sends information about a requested slice associated with the application entity based on a service description associated with the application entity.

In one embodiment, a third method is disclosed for establishing a trust relationship between an application entity and a wireless communication network. The third method may be performed by a network function of a network device such as the network apparatus 600. In one embodiment, the third method includes receiving, at a first network function, an authentication request from an application entity that does not have a trust relationship with the first network function, the authentication request comprising a client credential assertion (“CCA”) token for a second network function that has a trust relationship with the first network function and the application entity.

In one embodiment, the third method includes verifying, at the first network function, that the CCA token is associated with the second network function. In some embodiments, the third method includes sending, from the first network function to the application entity, an authentication result in response to verifying the CCA token, the authentication result comprising a CCA token of the first network function for establishing a security association between the application entity and the third network function.

In one embodiment, the third method includes receiving, at the first network function, a first secret token in the authentication request and authenticating the application entity in response to the received first secret token matching a first secret token that is previously-received from the second network function.

In some embodiments, the third method includes receiving, at the first network function, an application identifier for the application entity in the authentication request and authenticating the application entity in response to the received application identifier matching an application identifier that is previously-received from the second network function.

In one embodiment, the third method includes, in response to authenticating the application entity, sending, from the first network function, the application identifier and an application entity identifier to the third network function for use in authenticating the application entity with the third network function.

In one embodiment, the third method includes generating, at the first network function, a second secret token at the first network function and sending the second secret token to the third network function for use in authenticating the application entity with the third network function.

In one embodiment, the third method includes sending, from the first network function, the second secret token to the application entity for use in authenticating the application entity with the third network function. In one embodiment, the authentication result further comprises a network address identifier (“NAI”) for a third network function that does not have a trust relationship with the application entity.

In one embodiment, a third apparatus is disclosed for establishing a trust relationship between an application entity and a wireless communication network. The third apparatus may be embodied as a network function of a network device such as the network apparatus 600. In one embodiment, the third apparatus includes a transceiver that receives, at a first network function, an authentication request from an application entity that does not have a trust relationship with the first network function, the authentication request comprising a client credential assertion (“CCA”) token for a second network function that has a trust relationship with the first network function and the application entity.

In one embodiment, the third apparatus includes a processor that verifies, at the first network function, that the CCA token is associated with the second network function. In some embodiments, the third apparatus includes a transceiver that sends, from the first network function to the application entity, an authentication result in response to verifying the CCA token, the authentication result comprising a CCA token of the first network function for establishing a security association between the application entity and the third network function.

In one embodiment, the third apparatus includes a transceiver that receives, at the first network function, a first secret token in the authentication request, the application entity authenticated in response to the received first secret token matching a first secret token that is previously-received from the second network function.

In some embodiments, the third apparatus includes a transceiver that receives, at the first network function, an application identifier for the application entity in the authentication request, the application entity authenticated in response to the received application identifier matching an application identifier that is previously-received from the second network function.

In one embodiment, the third apparatus includes, in response to authenticating the application entity, a transceiver that sends, from the first network function, the application identifier and an application entity identifier to the third network function for use in authenticating the application entity with the third network function.

In one embodiment, the third apparatus includes a processor that generates, at the first network function, a second secret token at the first network function, the second secret token sent to the third network function for use in authenticating the application entity with the third network function.

In one embodiment, the third apparatus includes a transceiver that sends, from the first network function, the second secret token to the application entity for use in authenticating the application entity with the third network function. In one embodiment, the authentication result further comprises a network address identifier (“NAI”) for a third network function that does not have a trust relationship with the application entity.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus, comprising:
a transceiver that:
sends, from an application entity, a request to a first network function to authenticate the application entity to a second network function that does not have a trust relationship with the application entity, the first network function having a trust relationship with the application entity and the second network function, the request comprising at least one verifiable parameter for authenticating the application entity; and
receives a result of the authentication from at least one of the first and second network functions; and
a processor that establishes a trust relationship between the application entity and the second network function such that the application entity can communicate with the second network function in response to the application entity being authenticated.

2. The apparatus of claim 1, wherein the transceiver is configured to receive, from the first network function, a network address identifier (“NAI”) of the second network function, and a client credential assertion (“CCA”) token associated with the first network function.

3. The apparatus of claim 2, wherein the transceiver is configured to:
send, from the application entity, the management message to the second network function using the NAI of the second network function, the second management message comprising an application entity identifier, an application identifier, and the CCA token of the first network function; and
receive, from the second network function, a second secret token, an NAI of a third network function, and a CCA token associated with the second network function in response to the CCA token associated with the first network function being verified.

4. The apparatus of claim 3, wherein the transceiver is configured to send a first secret token to the second network function and further receiving the second secret token, the NAI of the third network function, and the CCA token associated with the second network function in response to the first secret token being verified.

5. The apparatus of claim 2, wherein the transceiver is configured to:
send, from the application entity, a management message to a third network function using the NAI of the third network function, the third management message comprising the application entity identifier, the application identifier, and the CCA token of the second network function; and
receive, from the third network function, the result of authenticating the application entity in response to the CCA token associated with the second network function being verified at the third network function.

6. The apparatus of claim 5, wherein the transceiver is configured to send the second secret token to the third network function and further receiving the authentication result in response to the second secret token being verified.

7. The apparatus of any preceding claim, wherein the processor is configured to determine application entity information for the application entity, the application entity information comprising at least one of an application entity identifier, an application identifier, and management information for authenticating the application entity with a mobile wireless communication network.

8. The apparatus of any preceding claim, wherein the management information comprises a service description associated with the application entity, the service description translated into a slice blueprint at the second network function to derive the application identifier.

9. An apparatus, comprising:
a processor that generates, at a first network function, a client credential assertion (“CCA”) token for the first network function; and
a transceiver that:
sends, from the first network function, an authentication request to a second network function for authenticating an application entity, the authentication request comprising the CCA token of the first network function, the application entity having a trust relationship with the first network function and not the second network function;
receives, at the first network function from the second network function, a response to the authentication request comprising a network address identifier (“NAI”) for the second network function; and
sends, from the first network function to the application entity, the response to the authentication request comprising the NAI for the second network function and the CCA token of the first network function for establishing a security association between the application entity and the second network function.

10. The apparatus of claim 9, wherein the processor is configured to determine a first secret token at the first network function in response to a request to authenticate the application entity to the second network function that has a trust relationship with the first network function and does not have a trust relationship with the application entity.

11. The apparatus of claim 10, wherein the authentication request further comprises the first secret token, an identifier for the first network function, and an application identifier for the application entity for verifying the authentication request and authenticating the application entity.

12. An apparatus, comprising:
a transceiver that receives, at a first network function, an authentication request from an application entity device that does not have a trust relationship with the first network function, the authentication request comprising a client credential assertion (“CCA”) token of a second network function that has a trust relationship with the first network function and the application entity; and
a processor that verifies, at the first network function, that the CCA token is associated with the second network function,
wherein the transceiver sends, from the first network function to the application entity, an authentication result in response to verifying the CCA token, the authentication result comprising a CCA token of the first network function for establishing a security association between the application entity and the third network function.

13. The apparatus of claim 12, wherein the transceiver is configured to receive, at the first network function, a first secret token in the authentication request and authenticating the application entity in response to the received first secret token matching a first secret token that is previously-received from the second network function.

14. The apparatus of claim 13, wherein the transceiver is configured to:
receive, at the first network function, an application identifier for the application entity in the authentication request, the application entity authenticated in response to the received application identifier matching an application identifier that is previously received from the second network function; and
in response to authenticating the application entity, send, from the first network function, the application identifier and an application entity identifier to the third network function for use in authenticating the application entity with the third network function.

15. The apparatus of any of claims 12 to 14, wherein:
the processor is configured to generate, at the first network function, a second secret token at the first network function, the second secret token sent to the third network function for use in authenticating the application entity with the third network function; and
the transceiver is configured to send, from the first network function, the second secret token to the application entity for use in authenticating the application entity with the third network function.
